(19) United States
(12) Patent Application Publication
(10) Pub. No.: US 2002/0130897 A1
(43) Pub. Date: Sep. 19, 2002

(54) Method of composing a list of TV or radio programs from a given transmission schedule

(75) Inventor: Astrid Mathilda Ferdinanda Dobbelaar, Eindhoven (NL)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 09/992,921

(22) Filed: Nov. 5, 2001

(30) Foreign Application Priority Data
Nov. 8, 2000 (EP) 00203923.8

(51) Int. Cl. G09G 5/00

(52) U.S. Cl. 345/719

(57) ABSTRACT

The invention concerns the visual ordering of broadcast events (101, 102, . . . ) or programs scheduled for recording: all events (110, 102, 111) selected from a program guide (10) for recording form a list (20). They are displayed on a screen with a timeline (30), at the exact positions on this line, which correspond to the times when they will be broadcast. This gives the user a clear overview of the sequence of the programs (110, 102, 111) in the list. Overlap of programs may be resolved by the assignment of priorities (A, B, C) to the programs, programs of higher priorities being recorded first.

The invention relates to a method of composing a list of TV or radio programs from a given transmission schedule, and to a controller for an audio and/or video recording and/or displaying device adapted to execute the method.

With the increasing number of channels and programs available on radio and TV, sophisticated systems have been proposed to allow a consumer to more easily select the programs he wishes to see, listen to or record. One such system is disclosed in WO 96/31980. This system includes a set-top box for a TV set, the box receiving information about the schedule of programs to be broadcast in a given period, e.g. the next week. The system includes a graphical display, which may be the screen of the TV set with which the system is used, to present the schedule of programs as a table ordered according to time and channel. Thus, programs of each channel may be arranged in vertical columns, the rows of the table corresponding to the times scheduled for the programs. The user may move a cursor or the like through the table, scroll the table, if necessary, and select a program from the table. The selected program is highlighted to mark it, and it is displayed on the TV screen or recorded on a Video Cassette Recorder (VCR) at the time of its transmission.

Though the system described above presents the schedule of programs in a well ordered manner, there are several drawbacks. Firstly, the display of the table requires a lot of space due to the large number of available programs to be depicted. To find out which programs have been tagged for either viewing or recording, the user has to scroll extensively through all channels. As a result, the user does not have a complete overview when it comes to finding out which programs will be displayed or recorded and when. In the case of two programs tagged for viewing in (partly) overlapping time slots, it is left to the user to find this out while the program scheduled first is being watched, and in the case of recording, it is either left to the user to exclude recording overlaps, or the user is given an error message which prompts to cancel one of the two programs.

Similar systems as in WO 96/31980 are disclosed in WO 92/04801 and EP 0 682 452 A2 and have the same limitations and drawbacks.

Therefore, it is an object of the present invention to provide a method and a device that aid a user to compose a list of TV or radio programs from a given transmission schedule, the list being suited as a guide for recording or viewing the programs. Moreover, the system should provide the user with visual help to prioritize the viewing/recording scheme for selected programs.

These objects are achieved by a method according to claim 1 and a controller according to claim 7.

With the method according to the invention, a list of TV or radio programs can be composed from a given program transmission schedule. The method comprises the steps of:

(a) selecting a program from the schedule and adding it to the list,

(b) graphically representing the programs of the list as items on a timeline, the length and position of each item corresponding to the duration and time of transmission of the corresponding program; the items may be bars, scaled representative snapshots or icons (“thumbnails”), text bars etc.;

(c) selecting a program from the list and removing it from the list, if necessary,

(d) repeating steps (a), (b), and (c) until the list is complete.

The program transmission schedule may be represented in any way that is convenient to the user and technically feasible. Therefore, the schedule may simply consist of a text list that can readily be presented on a limited-size screen. If there is enough space on the screen, the schedule may be presented graphically, too. When the user has selected a program from the schedule, this program is graphically represented as an item, e.g. a bar, on a timeline together with the other programs that have already been added to the list. In this representation, the length and position of each item/bar corresponds to the duration and time of transmission of the corresponding program. The user therefore immediately and intuitively sees if two or more programs of the list overlap in time. Since only one program can be viewed or recorded at a time, the user therefore has to modify the composition of the list to resolve these conflicts. He may, for example, remove one or more programs from the list until there is no more overlap. This management of the list of programs is largely supported by the graphical representation of the list on a timeline, which helps the user to quickly find a choice that best suits his preferences with minimal loss of valuable programs.

According to a preferred embodiment of the invention, a priority is assigned to some or all of the programs of the list, and programs or parts of programs overlapping in time are processed according to their priorities. The assignment of a priority makes it possible to leave partially overlapping programs on the list and, instead of removing one of them, to prescribe an order for processing the programs. For example, when a program of higher relevance to the user and a program of lower relevance to the user partially overlap, the program of higher relevance may be recorded completely, while only those parts of the program of lower relevance are recorded which do not overlap with the other program.

Therefore, an intrinsic usability quality of the invention is the possibility of assigning a priority to some or all of the programs of the list: programs or parts of programs overlapping in time are processed according to their priorities. In a visual embodiment of the invention the process of prioritizing may be as simple as “dragging” the preferred program to the foreground, which visually indicates that is has priority over the program in the background.

According to another embodiment of the invention, some or all of the programs of the list are assigned starting times and/or stopping times, and they are processed according to said times. This feature allows a user to record or view only those parts of a program he is interested in. Moreover, this gives the user another tool to solve the problem of overlapping transmission times.

A preferred use of the list composed by the user consists of using it to control the recording of programs on a recording device and/or to control the display of programs on an audio and/or video reproducing device.

The invention also relates to a controller for an audio and/or video recording and/or reproducing device. The controller includes

(A) a memory for storage of the schedule of available TV or radio programs,

(B) an input device allowing a user to enter selections,

(C) a display unit for graphically representing programs of a list of programs, the controller being adapted to

(D) execute a method as described above, in order to compose a list of programs,

(E) control the audio and/or video recording and/or reproducing device so as to process the programs according to said list.

The controller can implement the method described above and can process the list composed by this method. Consequently, the advantages resulting from the method can be achieved. Moreover, the controller can be modified so as to realize the preferred variants of the method described above.

The invention will now be described in more detail, by way of example, with reference to the accompanying drawing. In the drawing:

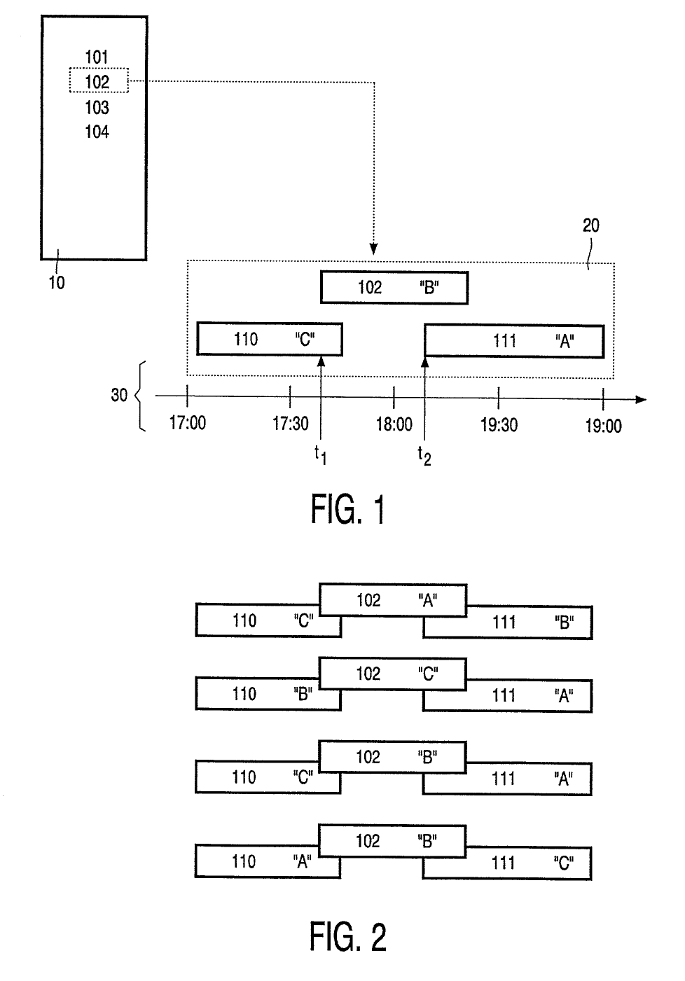

FIG. 1 schematically shows the composition of a list of programs from a schedule;

FIG. 2 shows different priority situations in the case of three partially overlapping programs.

FIG. 1 schematically shoots the composition of a list 20 of programs from a schedule 10 that contains all programs 101, 102, 103, 104, . . . A program 102 selected from the schedule 10 by the user is “dragged” to the timeline 30, where the programs 110, 111, 102 are graphically represented as bars. The lengths and positions of the bars correspond exactly to the durations and transmission times of the programs. Therefore, the user immediately and intuitively sees the ordering of the selected programs in time.

Particularly, the user readily notices if and where problems occur due to overlapping transmission times. There are at least three different ways to resolve such an overlap:

(i) Removing programs from the list until there is no more overlap. The graphical representation is then also useful, because the user can identify programs whose removal will resolve several collisions at a time. For example, in FIG. 1 the program 102 overlaps with both the program 110 and the program 111. Therefore, removal of the single program 102 is generally preferred over removal of the two programs 110 and 111.

(ii) Assigning priorities to the programs. In the case of an overlap, programs of higher priorities take precedence, i.e. are viewed or recorded first. Programs of lower priority are processed only once the processing of programs of higher priorities is finished. In the FIG., a priority “B” is assigned to the program 102, a priority “C” is assigned to the program 110 and the highest priority “A” is assigned to the program 111. Therefore, the recording of the program 110 is interrupted at an instant t₁, the program 102 is recorded from its start at t₁ until t₂, and the program 111 is recorded from its start at t₂ until its end.

(iii) Assigning individual starting times and stopping times to the programs. In this case, the user must determine explicitly when to start and stop the processing of a program, overlaps thus being avoided “manually”.

FIG. 2 shows a more intuitive representation of the selected programs 102, 110, 111, and their priorities. In this case, the bars representing the programs are at least partially arranged at the same vertical position. Priority of a first program over a second program is represented by arranging the first program in the foreground and the second program in the background. Thus, the three selected programs 102, 110, 111 may have the four different relationships shown in FIG. 2. The user can change the relationships simply by clicking, pointing, verbally indicating the event titles, e.g. “Program 102 over Program 110” etc.

In summary, the invention concerns the visual ordering, in an intuitive way, of broadcast events scheduled for viewing or recording: all events selected for recording from a program guide are automatically “dragged” into a screen with a timeline to the exact positions on that line, which correspond to the times when they will be broadcast.

Unlike in text lists, where an error message is the only way to indicate that the user is attempting to record a number of programs at a time greater than the number of tuners/recorders available, it is immediately visible when a capacity problem occurs. By visually ordering the programs to be recorded, it is easy to assign priorities and thus often resolve the problem. It is even possible to choose to record parts of programs by allowing programs to partly overlap in the visual map. The preparation of a viewing list (a visual tag-list of events selected for viewing in the near future) works exactly the same way.

| List of references: | |
|---|---|
| 10 | schedule of programs |
| 20 | list of programs |
| 30 | timeline |
| 101, 102, 103, 104, | programs |
| 110, 111 | |

1. A method of composing a list (20) of TV or radio programs from a given transmission schedule (10) of the programs, comprising the steps of:
(a) selecting a program (102) from said schedule and adding it to the list,
(b) graphically representing the programs (102, 110, 111) of the list as bars over a timeline (30), the length and position of each bar corresponding to the duration and time of transmission of the corresponding program,
(c) selecting a program and removing it from the list, if necessary,
(d) repeating steps (a), (b), and (c) until the list is complete.

2. A method according to claim 1, characterized in that a priority is assigned to some or all of the programs (102, 110, 111) on the list (20), and programs or parts of programs overlapping in time are processed according to their priorities.

3. A method according to claim 2, characterized in that the values of the priorities are automatically initialized according to the sequence in which the programs are added to the list.

4. A method according to one or more of claims 2 to 3, characterized in that overlapping programs of the list are visually ordered as being in the foreground and in the background, respectively, and that the program in the foreground has the higher priority.

5. A method according to one or more of the preceding claims, characterized in that the list (20) is used to control the recording of programs on a recording device.

6. A method according to one or more of the preceding claims, characterized in that the list (20) is used to control the display of programs on an audio and/or video reproducing device.

7. A controller for an audio and/or video recording and/or reproducing device, including
(A) a memory for storage of the schedule (10) of available TV or radio programs,
(B) an input device allowing a user to enter selections,
(C) a display unit for graphically representing programs of a list (20) of programs, the controller being adapted to
(D) execute a method according to at least one of the claims 1 to 6, in order to compose a list of programs,
(E) control the audio and/or video recording and/or reproducing device so as to process the programs according to said list.
